(19) United States
(12) Patent Application Publication
(10) Pub. No.: US 2007/0104033 A1
(43) Pub. Date: May 10, 2007

(54) Sandglass assembly

(76) Inventor: Lin Yuan-Hsin Tsai, Taipei Hsien (TW)

Correspondence Address: Lin Yuan-Hsin Tsai, 235 Chung-Ho, Box 8-24, Taipei, TW

(21) Appl. No.: 11/269,091

(22) Filed: Nov. 9, 2005

(51) Int. Cl. G04F 1/04

(52) U.S. Cl. 368/93

(57) ABSTRACT

A sandglass assembly comprises a seat having a stand shaft; a bottle being a transparent body and containing with sands; two symmetrical receiving grooves being formed within the bottle for receiving sands; a sand hole being formed between the two symmetrical receiving grooves for communicating the two receiving grooves; a predetermined amount of sands can pass through the sand hole; a frame for retaining the bottle; and the two receiving grooves are viewed clearly; a connecting unit installed between the shaft and the frame; and the connecting unit being liftable, descendable and rotatable along the shaft; the frame being rotatable along the connecting unit so that the bottle retained to the frame is turnable. The height and orientation of the bottle with respect to the shaft is adjustable. Furthermore, the bottle is turnable easily and the flow direction of the sands in the bottle can be seen easily.

### FIELD OF THE INVENTION

The present invention relates to sandglasses, and particularly to a sandglass assembly, wherein the height and orientation of the bottle of the sandglass assembly with respect to the shaft is adjustable so that the bottle is adjusted to a position in that the bottle can be seen clearly. Furthermore, the bottle is turnable easily and the flow direction of the sands in the bottle can be seen easily.

### BACKGROUND OF THE INVENTION

Referring to FIG. 7, a prior art sandglass 5 is illustrated. In the prior art sandglass, a frame 50 is installed with a bottle 51. The frame 50 is combined to the bottle 51. When it is desired to change the flow direction of the sands 52 in the bottle 51, it is necessary to turn the frame 50 and the bottle 51. More power is necessary and the operation is the inconvenient. Thereby the bottle 51 is integrally installed to the frame 50, and thus the bottle 51 cannot be lifted or descended with respect to the frame 50 and the orientation of the bottle 51 cannot be adjusted. Thereby it is often that the people cannot view the sandglass clearly.

Furthermore, referring to FIG. 8, another prior sandglass 6 is illustrated. It is illustrated that the center portion of each of two sides of a frame 60 is pivoted to one of two posts 64 of a seat 63. Thereby the flow direction of the sands 62 in the sandglass can be changed with less power. However since two sides of the frame 60 are pivoted to the two posts 64, the bottle 61 can be lifted or descended with respect to frame 60 and the orientation of the bottle 61 cannot be adjustable. Thereby the positions for viewing the sandglass are also confined.

### SUMMARY OF THE INVENTION

Accordingly, the primary object of the present invention is to provide a sandglass assembly, wherein the height and orientation of the bottle of the sandglass assembly with respect to the shaft is adjustable so that the bottle is adjusted to a position in that the bottle can be seen clearly. Furthermore, the bottle is turnable easily and the flow direction of the sands in the bottle can be seen easily.

To achieve above objects, the present invention provides a sandglass assembly which comprises a seat having a stand shaft; a bottle being a transparent body and containing with sands; two symmetrical receiving grooves being formed within the bottle for receiving sands; a sand hole being formed between the two symmetrical receiving grooves for communicating the two receiving grooves; a predetermined amount of sands can pass through the sand hole; a frame for retaining the bottle; and the two receiving grooves are viewed clearly; a connecting unit installed between the shaft and the frame; and the connecting unit being liftable, descendable and rotatable along the shaft; the frame being rotatable along the connecting unit so that the bottle retained to the frame is turnable.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled perspective view of the present invention.

FIG. 3 is an assembled cross sectional view of the present invention.

FIG. 4 shows the lifting and descending operations of the present invention.

FIG. 5 shows the operation of axial rotation of the present invention.

FIG. 6 is a schematic view showing the turning operation of the present invention.

FIG. 7 is a perspective view of the prior art.

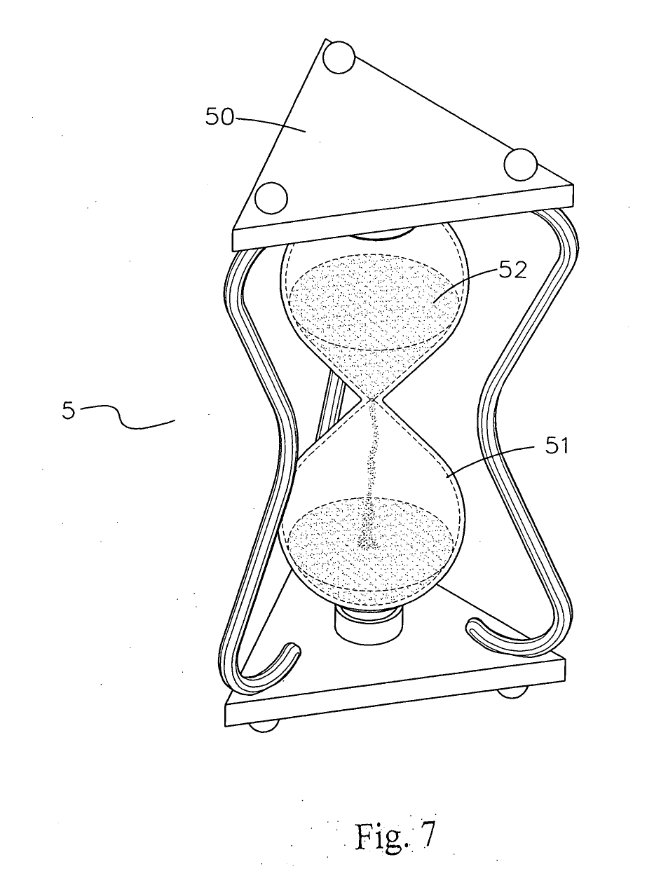

FIG. 8 is a perspective view about another portion sandglass.

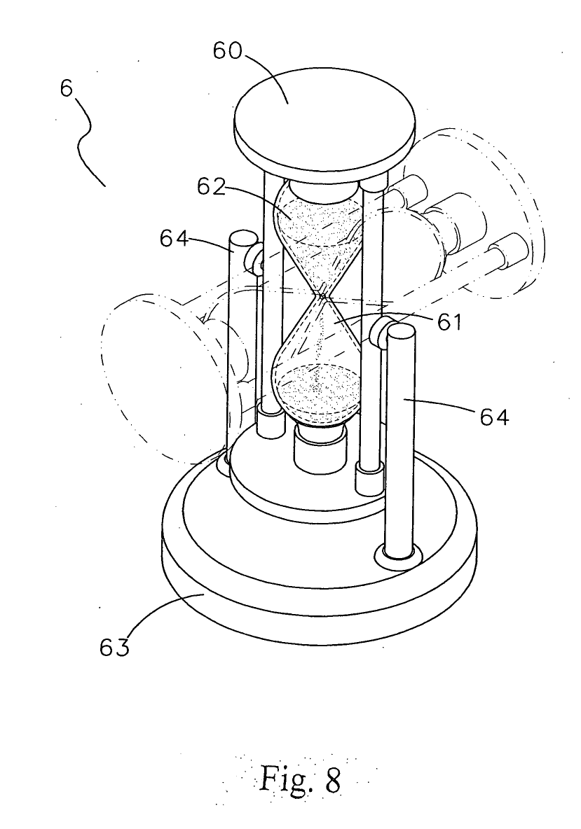

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

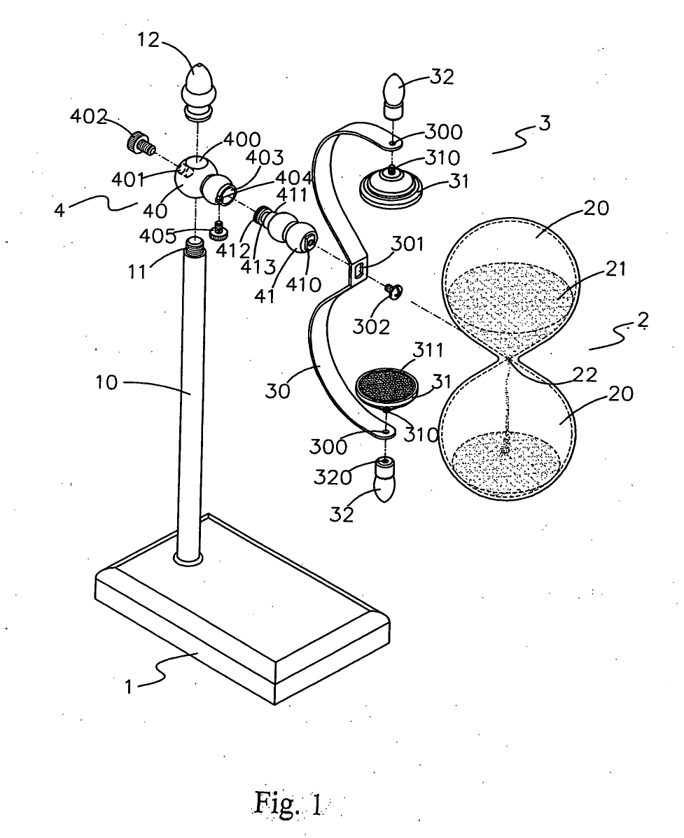

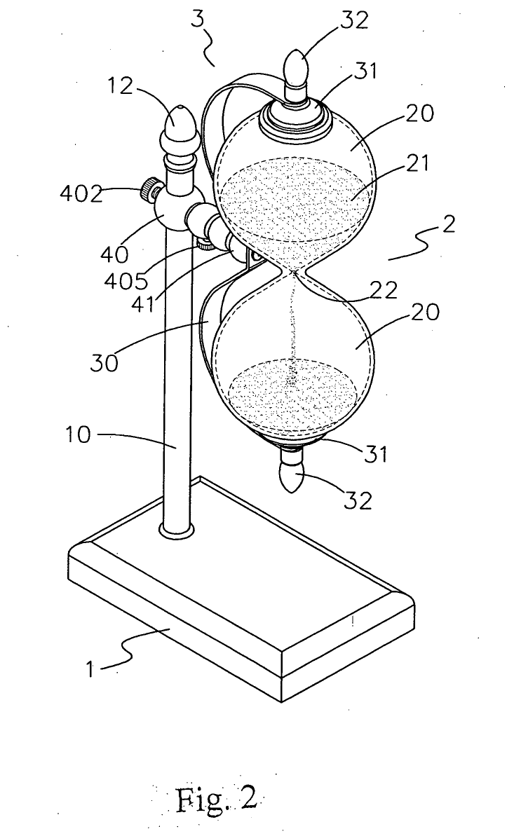

Referring to FIGS. 1 to 3, the structure of the present invention is illustrated. The present invention has the following elements.

A seat 1 has a stand shaft 10. A top of the shaft 10 has a threaded section 11 for screwing a limiting block 12.

A bottle 2 is a transparent body. Two symmetrical receiving grooves 20 are formed within the bottle 2 for receiving sands 21. A sand hole 22 is formed between the two symmetrical receiving grooves 20 for communicating the two receiving grooves 20. A predetermined amount of sands can pass through the sand hole 22.

A frame 3 has a frame strip 30, two pads 31, and two screw units 32.

Two ends of the frame strip 30 extend to two outer sides of the bottle 2. Each end of the frame strip 30 has a through hole 300. A center portion of the frame strip 30 has a slot 301. Furthermore, the frame strip 30 has a shape like “3”.

Each pad 31 has a threaded post 310 capable of passing through the through hole 300. Thereby the two pads 31 are positioned and clamp two ends of the bottle 2. Each pad 31 has a buffer layer at a side of the pad 31 contacting the bottle 2 for buffering the pressure between the bottle 2 and the pad 31.

Each screw unit 32 has a screw hole 320 for receiving the stem 310 passing through the through hole 300 so that the ends of the frame strip 30 are clamped between the two pads 32.

A connecting unit 4 has a retainer 40 and a rotary unit 41. The retainer 40 has a via hole 400 for receiving the shaft 10. One side of the connecting unit 4 has an adjusting screw hole 401 which is communicated to the via hole 400. An adjusting screw 402 screws into the adjusting screw hole 401. Another side of the connecting unit 4 is formed with a groove 403 and a lateral side of the groove 403 is formed with a limiting screw hole 404 which is communicated to the groove 403. A limiting screw 405 is screwed to the limiting screw hole 404.

One end of the rotary unit 41 has an embedding block 410 capable of being embedded into the slot 301 of the frame strip 30. A retaining screw 302 serves to retain the frame strip 30 to the rotary unit 41. Another end of the rotary unit 41 has a projection 411 capable of being inserted into the groove 403 so that the rotary unit 41 is rotatable around one side of the retainer 40. A periphery of the projection 411 is embedded with an O ring 412 and is formed with an annular trench 413. The O ring 412 serves to increase the friction force between the rotary unit 41 and the retainer 40 as the rotary unit 41 rotates around the retainer 40 so as to avoid the undesired rotation of the bottle 2. The annular trench 413 serves to receive the limiting screw 405 to prevent the release out of the rotary unit 41 from the retainer 40.

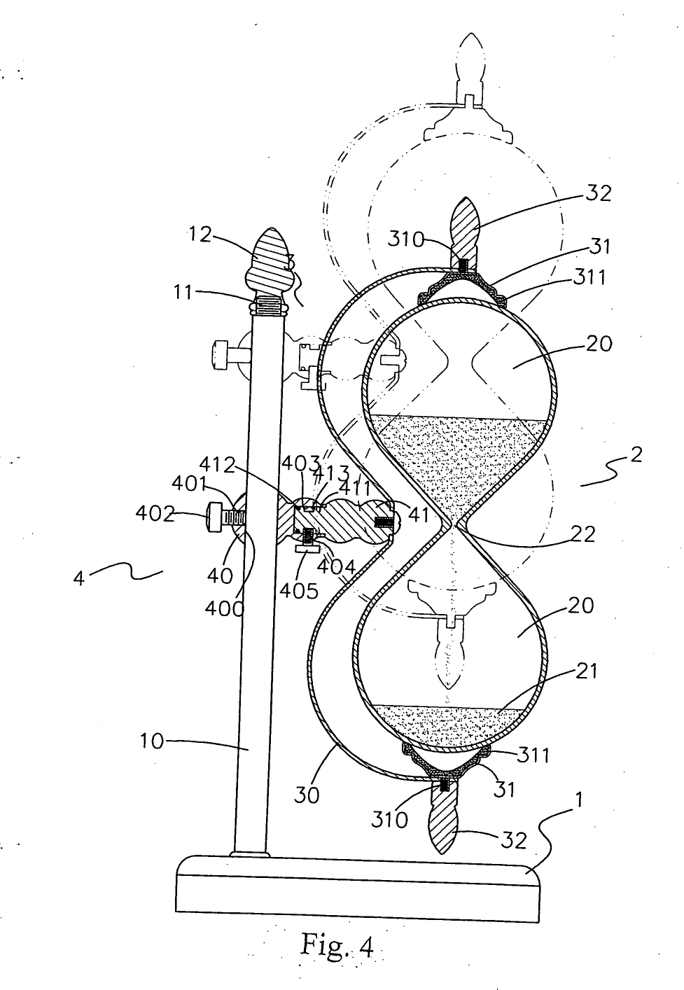

Referring to FIG. 4, when the adjusting screw 402 releases from the adjusting screw hole 401 so that one end portion of the adjusting screw 402 is not resists against the shaft 10, the connecting unit 4 is liftable or descendable along the shaft 10. Thus, the bottle 2 at one lateral side of the connecting unit 4 is moveable longitudinally. When it moves to a desired level, it is only necessary to tighten the adjusting screw 402, then the bottle 2 can be positioned on the shaft 10.

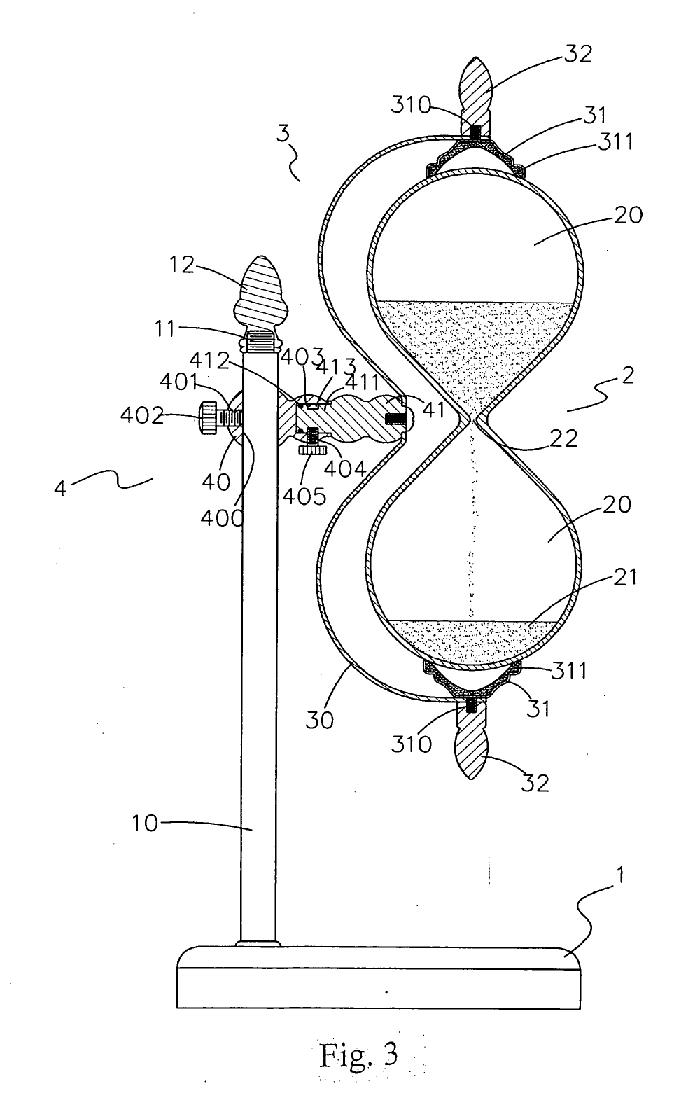

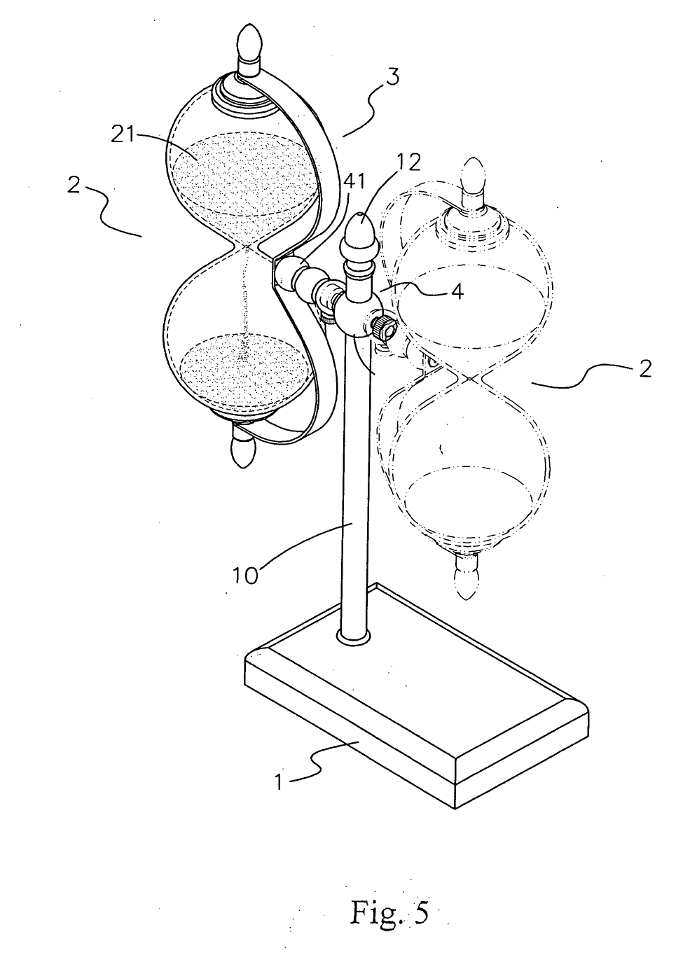

Referring to FIGS. 3 and 5, when it is desired to release the adjusting screw 402 in the adjusting screw hole 401, the connecting unit 4 can be rotated axially along the shaft 10. As a result, the bottle 2 installed at one side of the connecting unit 4 rotates axially. When the bottle 2 is adjusted to a desired height, it is only necessary to tighten the adjusting screw 402, it can be positioned on the shaft 10.

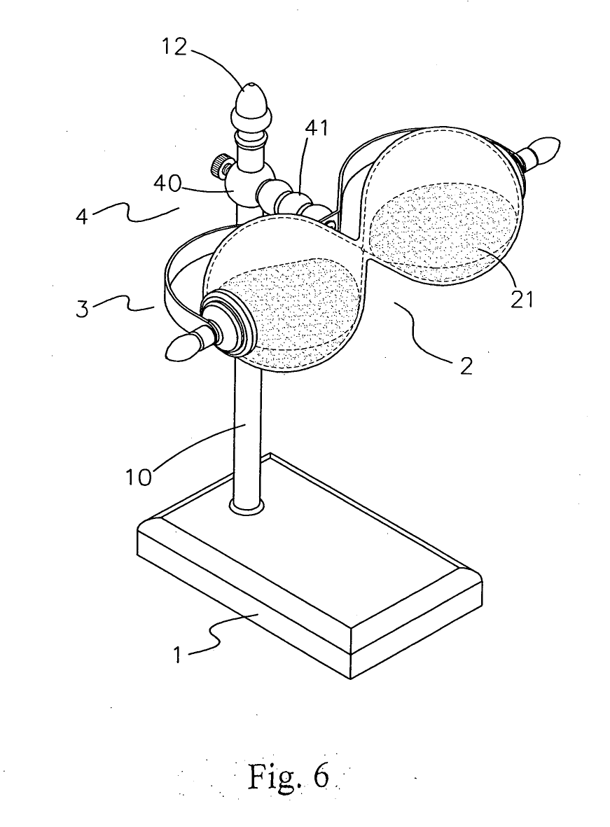

Referring to FIGS. 3, 6, when the limiting screw 405 is released from the limiting screw hole 404 so that the end portion of the limiting screw 405 does not resist against a bottom of the annular trench 413 of the projection 411, the rotary unit 41 is rotatable at one lateral side of the retainer 40. As a result, the bottle 2 at one side of the rotary unit 41 is turnable so as to adjust the flow direction of the sands 21. When the bottle 2 turns to a predetermined position, it is only necessary to tighten the limiting screw 405. Then the bottle 2 is positioned.

Therefore, by above mentioned structure, the height and orientation of the bottle 2 with respect to the shaft 10 is adjustable so that the bottle 2 is adjusted to a position in that the bottle 2 can be seen clearly. Furthermore, the bottle 2 is turnable easily and the flow direction of the sands in the bottle 2 can be seen easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A sandglass assembly comprising:
a seat having a stand shaft;
a bottle being a transparent body and containing with sands; two symmetrical receiving grooves being formed within the bottle for receiving sands; a sand hole being formed between the two symmetrical receiving grooves for communicating the two receiving grooves; a predetermined amount of sands can pass through the sand hole;
a frame for retaining the bottle; and the two receiving grooves are viewed clearly;
a connecting unit installed between the shaft and the frame; and the connecting unit being liftable and rotatable with respect to the shaft.

2. The sandglass assembly as claimed in claim 1, wherein the frame further comprising:
a frame strip; two ends of the frame strip extending to two outer sides of the bottle; each end of the frame strip having a through hole; a center portion of the frame strip having a slot;
two pads; each pad having a threaded post capable of passing through the through hole; thereby the tow pads being positioned and clamping two ends of the bottle;
two screw units; each screw unit having a screw hole for receiving the stem passing through the through hole so that the ends of the frame strip being clamped between the two pads.

3. The sandglass assembly as claimed in claim 1, wherein the frame strip has a shape like “3”.

4. The sandglass assembly as claimed in claim 1, wherein each pad has a buffer layer at a side of the pad contacting the bottle for reducing the pressure between the bottle and the pad.

5. The sandglass assembly as claimed in claim 1, wherein the connecting unit has a via hole for receiving the shaft and one side of the connecting unit has an adjusting screw hole which is communicated to the via hole; an adjusting screw screws into the adjusting screw hole.

6. A sandglass assembly comprising:
a seat having a stand shaft;
a bottle being a transparent body and containing with sands; two symmetrical receiving grooves being formed within the bottle for receiving sands; a sand hole being formed between the two symmetrical receiving grooves for communicating the two receiving grooves; a predetermined amount of sands can pass through the sand hole;
a frame for retaining the bottle; and the two receiving grooves are viewed clearly;
a connecting unit installed between the shaft and the frame; and the frame being rotatable installed along the connecting unit so that the bottle retained to the frame is turnable.

7. The sandglass assembly as claimed in claim 6, wherein the frame further comprising:
a frame strip; two ends of the frame strip extending to two outer sides of the bottle; each end of the frame strip having a through hole; a center portion of the frame strip having a slot;
two pads; each pad having a threaded post capable of passing through the through hole; thereby the tow pads being positioned and clamping two ends of the bottle;
two screw units; each screw unit having a screw hole for receiving the stem passing through the through hole so that the ends of the frame strip being clamped between the two pads.

8. The sandglass assembly as claimed in claim 6, wherein the frame strip has a shape like “3”.

9. The sandglass assembly as claimed in claim 6, wherein each pad has a buffer layer at a side of the pad contacting the bottle for reducing the pressure between the bottle and the pad.

10. The sandglass assembly as claimed in claim 6, wherein the connecting unit has a retainer and a rotary unit; the retainer is combined to the shaft and one end of the rotary unit is rotatably combined to the retainer and another end thereof is combined to the frame.

11. The sandglass assembly as claimed in claim 10, wherein the rotary unit has a groove and a limiting screw hole which is communicated to the groove; a limiting screw is screwed to the limiting screw hole; the rotary unit has a projection capable of being embedded into the groove; one end of the rotary unit has an embedding block capable of being embedded into the slot of the frame strip; a periphery of the projection is embedded with an O ring and is formed with an annular trench; and the annular trench serves to receive the limiting screw.

12. A sandglass assembly comprising:
a seat having a stand shaft;
a bottle being a transparent body and containing with sands; two symmetrical receiving grooves being formed within the bottle for receiving sands; a sand hole being formed between the two symmetrical receiving grooves for communicating the two receiving grooves; a predetermined amount of sands can pass through the sand hole;
a frame for retaining the bottle; and the two receiving grooves being viewed clearly;
a connecting unit installed between the shaft and the frame; and the connecting unit being liftable, descendable and rotatable along the shaft; the frame being rotatable installed along the connecting unit so that the bottle retained to the frame is turnable.

13. The sandglass assembly as claimed in claim 12, wherein the frame further comprising:
a frame strip; two ends of the frame strip extending to two outer sides of the bottle; each end of the frame strip having a through hole; a center portion of the frame strip having a slot;
two pads; each pad having a threaded post capable of passing through the through hole; thereby the tow pads being positioned and clamping two ends of the bottle;
two screw units; each screw unit having a screw hole for receiving the stem passing through the through hole so that the ends of the frame strip being clamped between the two pads.

14. The sandglass assembly as claimed in claim 12, wherein the frame strip has a shape like “3”.

15. The sandglass assembly as claimed in claim 12, wherein each pad has a buffer layer at a side of the pad contacting the bottle for buffering the pressure between the bottle and the pad.

16. The sandglass assembly as claimed in claim 12, wherein the connecting unit comprising:
a retainer having a via hole for receiving the shaft; one side of the connecting unit having an adjusting screw hole which is communicated to the via hole; an adjusting screw screwing into the adjusting screw hole;
a rotary unit having one end rotatable installed to the retainer and another end combined to the frame.

17. The sandglass assembly as claimed in claim 16, wherein the rotary unit has a groove and a limiting screw hole which is communicated to the groove; a limiting screw is screwed to the limiting screw hole; the rotary unit has a projection capable of being embedded into the groove; one end of the rotary unit has an embedding block capable of being embedded into the slot of the frame strip; a periphery of the projection is embedded with an O ring and is formed with an annular trench; the annular trench serves to receive the limiting screw.
